(19) United States
(12) Patent Application Publication
(10) Pub. No.: US 2025/0138221 A1
(43) Pub. Date: May 1, 2025

(54) ACCELERATING AND CUSTOMIZING CATASTROPHIC EVENT LOSS SIMULATION MODELING

(71) Applicant: Aon Global Operations SE, Singapore Branch, Singapore (SG)

(72) Inventor: Adrian McFarlane, Bishop's Stortford (GB)

(73) Assignee: Aon Global Operations SE, Singapore Branch, Singapore (SG)

(21) Appl. No.: 18/930,258

(22) Filed: Oct. 29, 2024

Related U.S. Application Data
(60) Provisional application No. 63/595,275, filed on Nov. 1, 2023.

(51) Int. Cl. G01W 1/10; G01V 20/00

(52) U.S. Cl. CPC G01W 1/10; G01V 20/00

(57) ABSTRACT

In an illustrative embodiment, systems and methods for producing a customized catastrophic risk model involve receiving a blend definition identifying two or more catastrophic risk models and at least one peril per model, calculating trial count(s) using available trials for each model, and sampling loss records from each model according to the trial count(s). The models may contain pre-aggregated and/or pre-simulated data. The models may have been created by pre-simulating each constituent event loss data set of an original catastrophic model into a year-loss data set, aggregating the year loss data to produce a set of sample year losses at level(s) relevant to a set of risk calculations, using the sample year losses to calculate gross loss characteristics, and comparing the gross loss characteristics to corresponding anticipated gross loss characteristics to confirm closeness in results.

### RELATED APPLICATIONS

This application claims the benefit of and priority to U.S. Provisional Patent Application Ser. No. 63/595,275 entitled “Accelerating and Customizing Catastrophic Event Loss Simulation Modeling” and filed Nov. 1, 2023. All above identified applications are hereby incorporated by reference in their entireties.

### BACKGROUND

Risk stemming from catastrophic events, including earthquakes, hurricanes, wildfires, and floods, is estimated and mitigated through statistical analysis using the output of catastrophic risk models, such as event loss table (ELT) and year loss table (YLT) models. An ELT table may include, for each unique event, an annual frequency, an expected (mean) loss if the event occurs, an independent component of the spread of the loss if the event occurs (Sdi), a correlated component of the spread of the loss if the event occurs (Sdc), and an exposure (e.g., maximum loss). A YLT table may include, for each projected year (e.g., year 1, year, 2, . . . year n), and each event, a projected amount of loss. An event loss file (ELF) provided by a catastrophic risk modeler may include a set of ELTs including a separate ELT per each distinct subset of at least a portion of subsets including geographic region, type of catastrophic event peril, entity, and line of business (e.g., each “loss segment”).

Statistical analysis of large-scale catastrophic loss data that applies ELFs across a wide swath of loss segments (e.g., a large portfolio of real estate holdings) takes a significant time and/or an enormous amount of processing resources to perform on an ad hoc basis. As such, to provide real-time or near real-time answers regarding catastrophic risk, data may be pre-simulated and pre-aggregated to the levels required by the reinsurance contracts, to eliminate a “heavy lifting” portion of the data preparation and analysis. However, pre-aggregated and pre-simulated data can require several terabytes of storage, steadily growing as the number of models and nuances of analysis expand.

To remedy this deficiency, the inventors recognized a need for a simplified on-demand process to reduce the storage requirements of pre-aggregated/pre-simulated data while providing similar if not superior speed and quality of results to the end user. Further, the inventors recognized a desire for customizable simulation involving statistical analysis blending data generated by multiple catastrophic event modeling entities and/or adjusting model data to produce additional “what if”′ options for risk analysis simulations.

### SUMMARY OF ILLUSTRATIVE EMBODIMENTS

In one aspect, the present disclosure relates to supporting real-time catastrophic loss calculations while eliminating the need to store large amounts of pre-aggregated data. For example, the systems and methods described herein may reduce the storage requirements in comparison to full pre-aggregation of catastrophic model data by about 80%. In some embodiments, rather than storing fully pre-aggregated data, the catastrophic model event loss data records are pre-simulated into a loss data set that can be used to rapidly calculate commonly requested risk calculations. In this manner, for a majority of the applications of the catastrophic event models (“cat models”), pre-simulated information is available for generating requested calculations. The pre-simulated loss data sets, for example, may be stored as new model versions of the original catastrophic models.

In some embodiments, the event loss data of an original catastrophic model is automatically pre-simulated into individual year event loss tables. The year event loss tables, further, may be pre-aggregated for each loss scenario.

In some embodiments, responsive to user activity in the system, data required for simulations is identified and automatically pre-aggregated for later use. For example, as a broker develops a structure for a target placement, creation of a placement layer involving data that has not yet been pre-aggregated may trigger a pre-aggregation process. In pre-aggregation, data may be re-sampled for loss segments associated with the identified placement layer.

In one aspect, the present disclosure relates to generating custom model versions using the pre-simulated loss data sets and pre-aggregated year loss data. The custom model versions, for example, may include blended models that combine event loss data from multiple catastrophic event models. The catastrophic event models, in particular, may be provided by different vendors, allowing for the opportunity to blend simulation data across multiple catastrophic model vendors into a single set of results. In another example, the custom model versions combine different variations of a same model version and/or different versions of a same model. Unlike methods that combine the outputs of different simulations (e.g., averaged simulation results), the blended models allow for rapid analysis since the model input data from each constituent catastrophic model identified by a blend definition is combined together and simulated once rather than executing multiple separate simulations on each model. Additionally, the underlying components of the blended model may be allocated different weights and/or directed to different perils-unique customization aspects enabled by blending the underlying data sets themselves rather than combining model execution output.

The foregoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is a block diagram of a system and environment for modelling mitigation options of catastrophic perils;

FIG. 2 illustrates a flow chart of an example method for generating pre-aggregated loss data and applying the loss data to approve a simplified catastrophe modelling output capable of producing real-time or near real-time catastrophic loss simulations;

FIG. 3 illustrates a flow chart of an example method for performing pre-aggregation of simulation data in anticipation of an upcoming simulation request;

FIG. 4 illustrates an example user interface for defining an adjusted version of catastrophe modelling output;

FIG. 5A and FIG. 5B illustrate flow charts of example methods for creating a blended model definition and applying the blended model to performing a catastrophic loss simulation;

FIG. 6 illustrates an example user interface for defining a blended model for catastrophic loss simulation;

FIG. 7A through FIG. 7C illustrate flow charts of an example method for creating a blended segment definition based on a blended model definition; and

FIG. 8 illustrates a flow chart of an example method for aggregating and simulating data based on a blended segment definition.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

The present disclosure relates to performing simulations using catastrophic risk modelling results to anticipate loss related to one or more perils. The perils can include damaging storms such as, in some examples, cyclones, hurricanes, typhoons, windstorms, and winter storms. The perils can include catastrophic events that could be natural, manmade, or a combination, such as floods, wildfires, and infectious disease. Further, the perils can include manmade perils such as, in some examples, terrorism, war, and/or cybersecurity breaches. The loss events simulated using the catastrophic risk models may cover a variety of loss such as financial loss, agricultural crop loss, property loss, industrial facility damage, utilities damage, and/or loss of life. Additionally, the simulated loss may relate to a number of lines of business such as, in some examples, commercial property, personal property, business interruption, workers' compensation, transportation physical damage, and/or public sector property. The catastrophic risk model data may originate from one of a number of vendors, such as AIR models produced by AIR Worldwide (now Verisk Analytics), Impact Forecasting ELEMENTS models by Aon Corporation, or RMS models produced by Risk Management Solutions, Inc. (by Moody's Analytics Company).

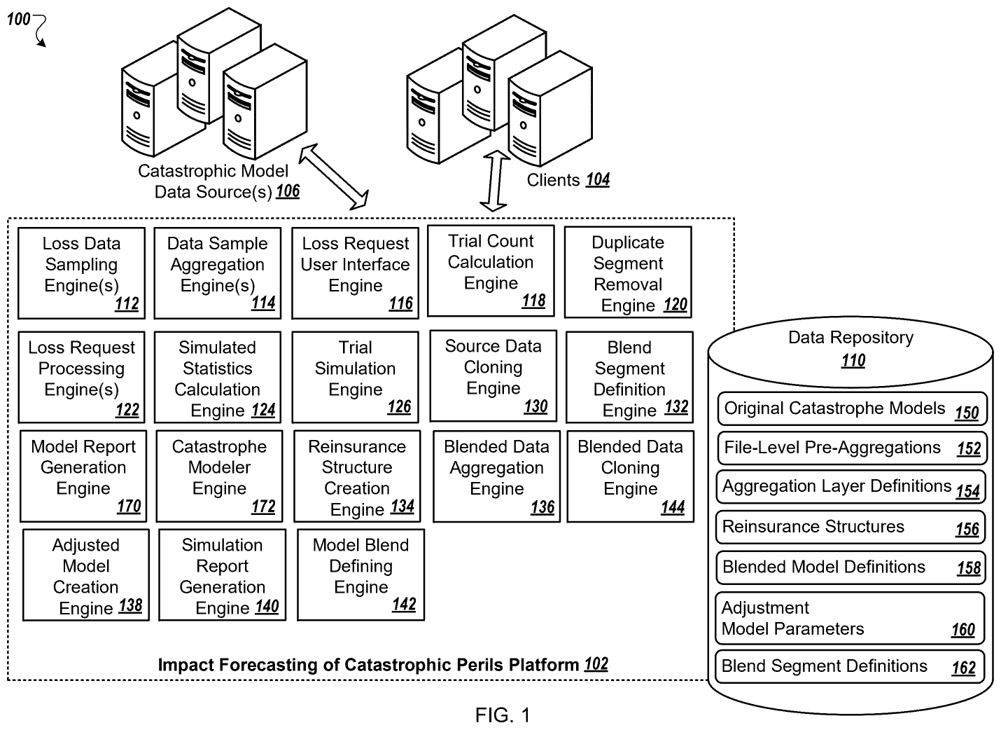

FIG. 1 is a block diagram of an example system 100 for modelling mitigation options related to catastrophic perils using customized sets of data. In some embodiments, a platform 102 obtains catastrophe modelling output from one or more catastrophic model data sources 106, samples the model data with one or more loss data sampling engines 112, aggregates loss samples to the levels required for reinsurance modelling with one or more data sample aggregation engines 114, and stores pre-aggregations 152 of the sampled data. Each aggregation represents a unique subset of an event loss file with scaling factors for each individual loss segment. The platform 102, in some embodiments, use the pre-sampled, pre-aggregated data in generating simulation results on behalf of clients 104. For example, the clients 104 may be supplied with loss request reports generated by a model report generation engine 170 based on simulated trial data.

In some embodiments, the platform 102 provides clients 104 with a model customization interface enabled by an adjusted model creation engine 138. The model customization tool, for example, may enable blending of source data from multiple catastrophic models in a manner defined by a particular client to obtain customized blended simulation results based on a blended model definition 158.

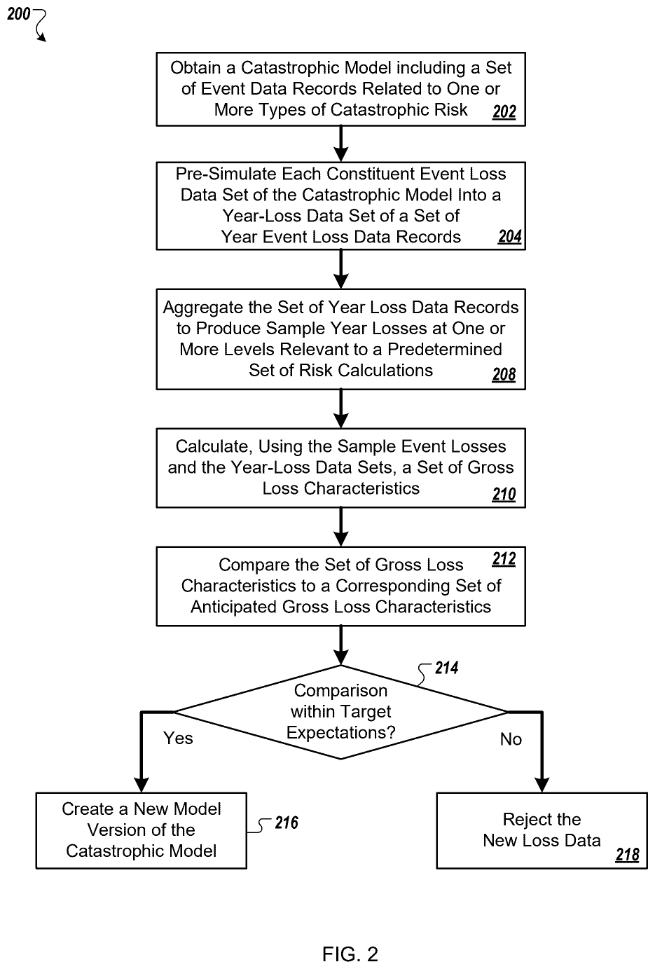

FIG. 2 illustrates a flow chart of an example method 200 for pre-aggregating catastrophic modelling output for future simulation. The catastrophic modelling output, for example, may represent an original model version derived from a model produced by a commercial catastrophic risk model vendor. The method 200, for example, may be performed by the impact forecasting of catastrophic perils platform 102 of FIG. 1. In some embodiments, the method 200 is performed on behalf of a catastrophic data modeler, such as one of the catastrophic model data sources 106 of FIG. 1.

In some implementations, a catastrophic data model is obtained including a set of event data records related to one or more types of catastrophic risk (202). The catastrophic data model, for example, may be uploaded by a catastrophic data modeler (e.g., a given one of the one or more catastrophic model data sources 106 of FIG. 1). The catastrophic data model may include catastrophic modelling output in the form of one or more event loss files (ELFs). Each ELF may contain multiple event loss tables (ELTs) representing different scopes of data. In some examples, ELTs may be provided for various characteristics or sets of characteristics, such as an individual ELT for each geographic region of a set of geographic regions (e.g., counties, states, provinces, etc.), each catastrophic peril of a set of catastrophic perils (e.g., earthquake, hurricane, flood, wildfire, etc.), each entity of a group of entities (e.g., governmental entities, insurers, etc.) and/or each line of business of a set of lines of business (e.g., commercial, residential, transportation, etc.). In an illustrative example, each unique combination of values of the sets of characteristics (e.g., Florida/flood/residential) is known as a “loss segment.” Each loss segment includes a set of loss scenarios (e.g., severities, etc.) attributable to the given peril.

In some implementations, each constituent event loss data set of the catastrophe modelling output is pre-simulated into an individual year loss data set of a set of year event loss data records (204). For example, each constituent ELT may be pre-simulated into an individual year event loss table (YELT) representing individual event loss samples over the course of a pre-defined number of years. The resultant YELT, for example, may include a set of rows where each row represents a sampled event within its year. Each year represents a possible outcome for the duration of the reinsurance contract (e.g., next 12 months, over the course of a particular contract, etc.), which may incur zero or more losses (e.g., financial loss in U.S. dollars or other currency, extent of damage estimate such as crop loss, etc.). The data in the YELT will be applicable to the loss segment of the corresponding ELT from which the simulated data in the YELT was generated. The simulations, for example, may be performed by a loss data sampling engine 112 of FIG. 1.

In some implementations, the set of year loss data records is aggregated to produce sample event losses at one or more levels relevant to a predetermined set of risk calculations (208). The aggregation, for example, may combine data derived from multiple YELTs representing the same loss scenario. The set of risk calculations may include, in some examples, exceedance probability (EP), probable maximum loss (PML), and/or average annual loss (AAL). The calculations may be performed by a data loss sample aggregation engine 114 of FIG. 1.

In some implementations, the year-loss data sets and sample year losses are used to calculate a set of gross loss characteristics (210). The gross loss characteristics, in some examples, can include the exceedance probability (EP) on an occurrence (OEP) or aggregate (AEP) basis, and/or average annual loss (AAL) within the ELT and YELT samples. The gross loss characteristics, in some embodiments, include overall totals and separate statistics for each simulated peril. In some embodiments, the simulated statistics calculation engine 124 of FIG. 1 calculates the gross loss characteristics.

In some implementations, the set of gross loss characteristics are compared to a corresponding set of anticipated gross loss characteristics derived by the catastrophic modeler (212). The gross loss characteristics, for example, may represent simulation output at various levels. The gross loss characteristics, for example, may be presented in a report for review by a catastrophic risk modeling organization that produced the simulation, such as, in some examples, AIR models produced by AIR Worldwide (now Verisk Analytics), RMS models produced by Risk Management Solutions, Inc. (by Moody's Analytics Company), etc. The report, for example, may be generated by a model report generation engine 170 of FIG. 1. The analytical characteristics of the loss data provided in the catastrophe modelling output (based on the event rates provided in the file), for example, may be compared with the simulated loss characteristics (based on the chosen event set). This comparison can be used to ensure that the simulated losses are sufficiently converged and are therefore suitable for use in simulations.

In some implementations, if the comparison meets with target expectations (214), a new model version of the catastrophic model is created (216). The new model version, for example, may be stored as one of the original catastrophe models 150 in the data repository 110 of FIG. 1.

If, instead, the comparison is outside target expectations, the loss data may be rejected (218). An analyst, for example, may reject the loss data. In this case, a model version will not be created, so it will never be available for use in simulations. The source data may be deleted.

Although described as a particular series of operations, in other embodiments, the method 200 may include more or fewer operations. In further embodiments, certain operations of the method 200 may be performed in a different order and/or at least partly in concurrence with other operations. Other modifications of the method 200 are possible.

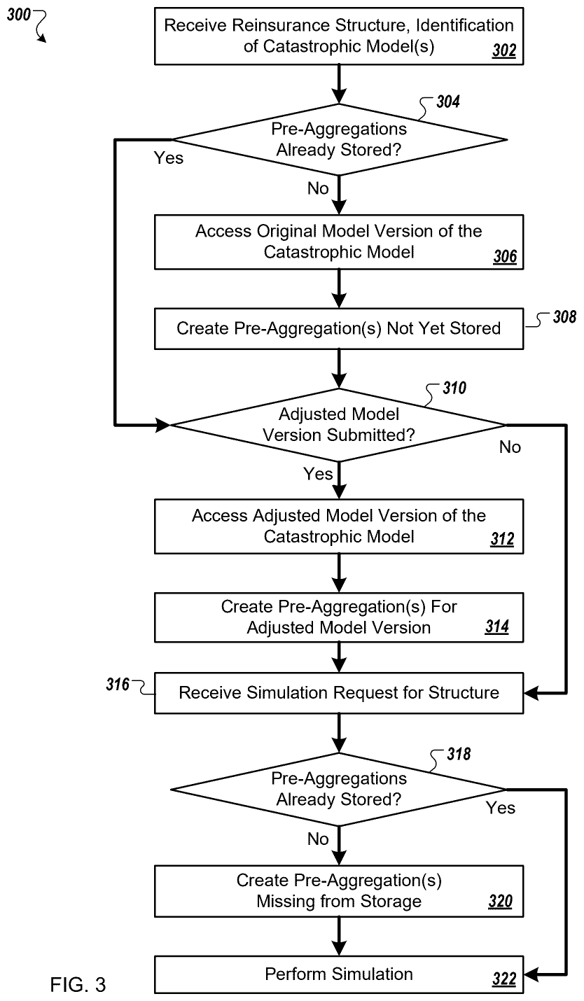

Turning to FIG. 3, a flow chart of a method 300 for applying an original model such as a model vetted and accepted using the method 200 of FIG. 2 is illustrated. The method 300, for example, may be performed by the impact forecasting of catastrophic perils platform 102 of FIG. 1.

In some implementations, the method 300 begins with receiving one or more simulation requests for a reinsurance structure along with identification of at least one corresponding catastrophic model (302). The reinsurance structure, for example, may be part of a set of reinsurance structures 156 stored to the data repository 110 of FIG. 1. In some embodiments, a portion of the reinsurance structures are recently created and/or recently edited reinsurance structures. For example, as reinsurance structures are being generated, the method 300 may obtain information on newly stored reinsurance structures. For example, a reinsurance structure creation engine 134 of FIG. 1 may release information regarding newly created or adjusted (e.g., edited) reinsurance structures. In some embodiments, the reinsurance structures are provided corresponding to a loss simulation request (e.g., submitted via a loss request user interface engine 116 of FIG. 1).

In some implementations, the method 300 checks whether pre-aggregations for the catastrophe modelling output are stored (304). The pre-aggregations, for example, may be stored as file-level pre-aggregations 152 in the data repository 110 of FIG. 1. Stored pre-aggregations, for example, may provide the opportunity for fast re-use of information that was already calculated. The pre-aggregations, for example, may represent commonly requested calculations within the platform 102 (e.g., via the loss request user interface engine 116).

In some implementations, if the pre-aggregations for the catastrophe modelling output are not yet stored (304), an original model version of the catastrophic model is accessed (306). The original model version, for example, may be accessed from the original catastrophe models 150 of the data repository 110 of FIG. 1. For example, the data sample aggregation engine(s) 114 of the platform 102 of FIG. 1 may access the original catastrophe models 150.

In some implementations, one or more aggregations missing from storage are created (308). The missing aggregations, for example, may include a new subset of the loss data as required for a particular reinsurance layer. For example, the addition of a Florida-only layer would require a Florida-only aggregation. In another example, a reinsurance layer may cover all US exposures for a single peril. In this case, an aggregation would be created for all US loss segments for the specified peril. In another example, the model may be an adjusted model version requiring pre-aggregations with new scaling factors applied. The data sample aggregation engine(s) 114 of the platform 102 of FIG. 1, for example, may create the missing aggregation(s).

In some implementations, whether or not the desired pre-aggregations were stored (304), if an adjusted model version is submitted (310), an adjusted model version of the catastrophic model is accessed (312). An adjusted model version, for example, may be created by a user via the adjusted model creation engine 138 of the platform 102 of FIG. 1. An adjusted model version, for example, may override underlying assumptions built into a base model. The adjusted model version, in other words, may be defined using one or more adjustment parameters, such as the adjusted model parameters 160 of FIG. 1. The adjustment based on each adjusted model parameter may be applied, in some examples, at the file level (ELF) and/or at the table level (ELT/YELT) and/or to a set of tables. The overriding, in some examples, may include an adjustment in losses (e.g., percentage, absolute value) across the board, per loss segment, and/or to a set of loss segments. In an illustrative example, the override can include increasing estimated losses for a line of business to reflect anticipated growth in that business area. In some embodiments, generation of an adjusted model version may automatically trigger pre-aggregation of the loss model, so that the adjustments may be applied to the original loss samples.

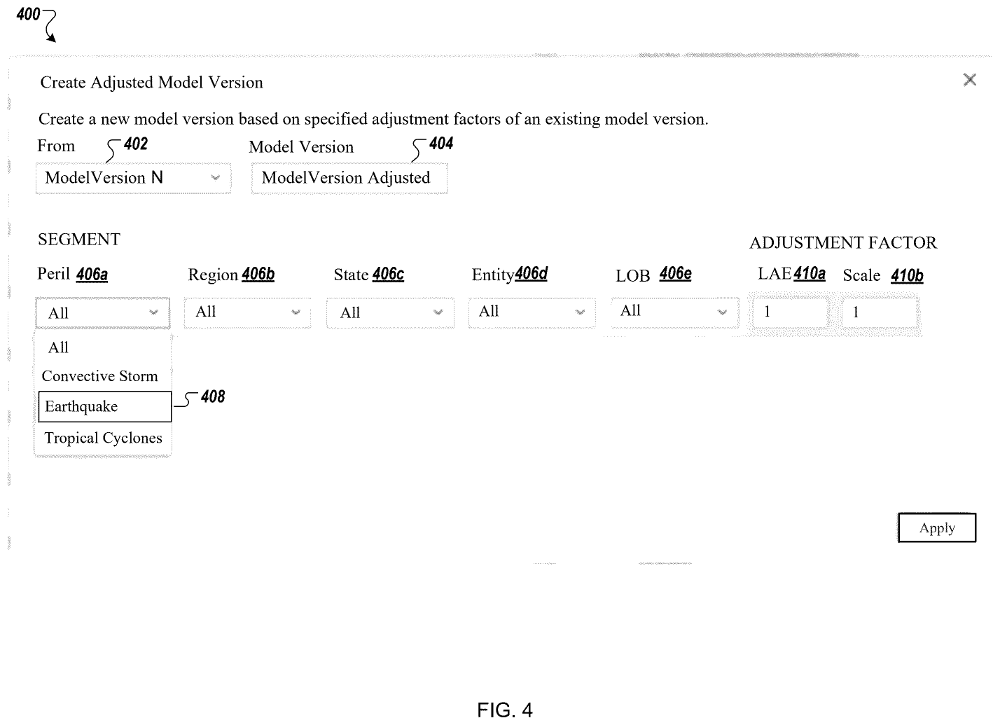

Turning to FIG. 4, in some implementations, an adjusted model version is created through a user interface such as an example user interface 400. As illustrated, in some embodiments, creating an adjusted model version begins with selecting a base catastrophe model 402, here identified as “ModelVersion N.” Further, a label may be created to name the adjusted model version, here labeled as a model version 404 “ModelVersion Adjusted.” To create model version 404, the user may adjust a particular loss segment through filtering between one and all of a set of loss segment characteristics 406, including a peril characteristic 406a, a region characteristic 406b, a state characteristic 406c, an entity characteristic 406d, and a line of business characteristic 406e. As illustrated, in the peril characteristic category 406a, the user is in the process of selecting an earthquake characteristic 408.

Once all desired filters are applied, in some embodiments, the user applies an adjustment factor including a loss adjustment expense (LAE) factor 410a and/or a scaling factor 410b. The LAE factor 410a, for example, may be adjusted to reflect an improvement in claim investigation practices. Conversely, the loss adjustment expense factor 410b may be increased to reflect an increasing complexity of review and/or an inflated baseline expense. The scaling factor 410b may be applied to increase or decrease estimated losses (e.g., in dollars, etc.) based on an anticipated movement from loss assumptions built into the selected base model 402.

In some implementations, additional loss segments may be adjusted (e.g., separate adjustments in the LAE factor 410a and/or the scale factor 410b based on peril 406a, region 406b, state 406c, entity 406d, and/or LOB 406e). The adjustments, for example, rescale losses for identified loss segments. In an illustrative example involving multiple scaling factors, a first scaling factor may be applied across all properties, while a second (cumulative) scaling factor may be applied to all commercial properties.

Returning to FIG. 3, in some implementations, pre-aggregations are created for the adjusted model version (314). The pre-aggregations, for example, may include common pre-aggregations typically desired for performing loss simulations, similar to the pre-aggregations generated by the method 200 of FIG. 2.

In some implementations, a simulation request identifying a structure is received (316). A broker, for example, may submit one or more reinsurance structures for simulation via the catastrophe modeler engine 172 of the platform 102 of FIG. 1. At least a portion of the reinsurance structures may have been built using the reinsurance structure creation engine 134 of the platform 102 of FIG. 1. The simulation request, for example, may identify one or more original catastrophe models 150 and/or one or more adjusted models (e.g., specified via custom model parameters 160 of the data repository 110 of FIG. 1).

In some implementations, the simulation request is checked to determine if pre-aggregations of data needed for the simulation are already stored (318). As described above, pre-aggregations may have been generated along the way, for example during storing the reinsurance structure(s) and/or specifying the adjusted model parameters. If additional pre-aggregations are needed (318), in some implementations, the pre-aggregations missing from storage are created (320). The pre-aggregations may be created, for example, as described in relation to steps 308 and/or 314 above.

In some implementations, the simulation is performed (322). For example, one or more simulations may be performed on one or more original models and/or adjusted models. The simulation may be performed, for example, by one or more loss request processing engines 122 of FIG. 1. The simulation report generation engine 140 of the platform 102 of FIG. 1 may generate results of the simulation.

Although described as a particular series of operations, in other embodiments, the method 300 may include more or fewer operations. For example, the simulation request may identify a blended or merged model. In the circumstance of a merged model, the outputs of multiple analyses developed from models produced by a single vendor may be merged. For example, if an analysis has been run for a first line of business, a second line of business may be added at a later time such that a merged line of business analysis is performed. The constituent pre-aggregations, in this circumstance, would be accessed and/or created. In further embodiments, certain operations of the method 300 may be performed in a different order and/or at least partly in concurrence with other operations. Other modifications of the method 300 are possible.

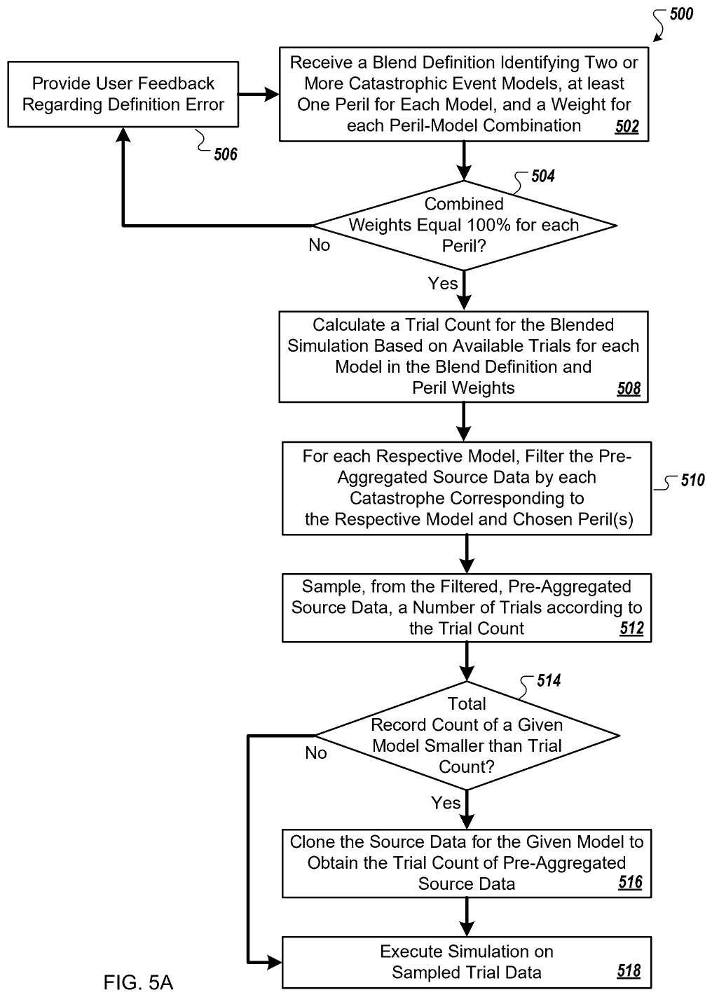

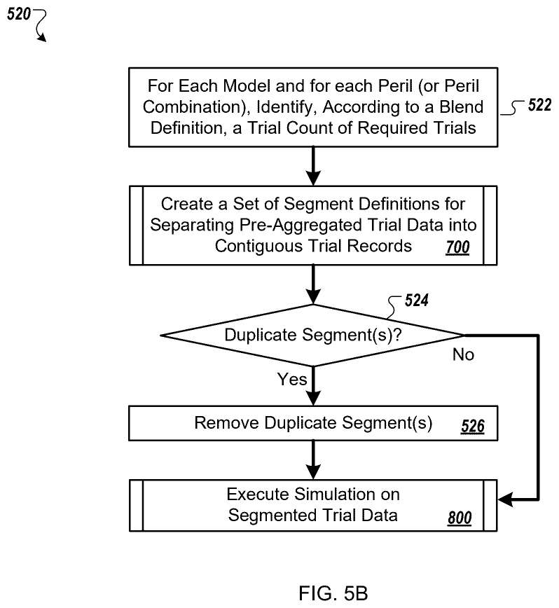

In some implementations, rather than running simulations on individual models, a user creates a bespoke blend definition for blending data sets representative of multiple models. In this manner, for example, a particular model vendor may be selected for different loss scenarios (e.g., different perils) and/or the analysis of multiple models may be blended to produce output related to a same loss scenario. Turning to FIG. 5A and FIG. 5B, flow charts are illustrated of example methods for producing and applying blended models. The blended models, for example, may be created and applied on the platform 102 of FIG. 1.

Turning to FIG. 5A, in some implementations, a method 500 for producing a blended model begins with receiving a blend definition identifying two or more catastrophic event models, at least one peril for each model, and a weight for each peril-model combination (502). The models may be provided by the same catastrophic risk model vendor or different model vendors. For example, the underlying models, in some embodiments, need not have the same data structure. One or more models included in the blend definition may be adjusted models, defined as described, for example, in relation to FIG. 3 and FIG. 4. The blend definition, for example, may be obtained from the blended model definitions 158 of the data repository 110 of FIG. 1. The blend definition may relate to one or more perils (e.g., natural disaster, man-made disaster, etc.). The perils may be specified in the blend definition and/or one or more models may inherently be linked to a particular peril (e.g., a wildfire-only catastrophic risk model). A blend definition example follows:

TABLE 1
Example simple blend definition

| Model Version | Peril | Weight |
|---|---|---|
| ModelVersion A | WS | 50% |
| ModelVersion B | WS | 50% |
| ModelVersion B | EQ, OW, WT, WF | 100% |

In the above example, WS=windstorm, EQ=earthquake, OW=Other Wind, WT=winter storm, and WF=wildfire. In some embodiments, the blend definition is created via a model blend defining engine 142 of FIG. 1.

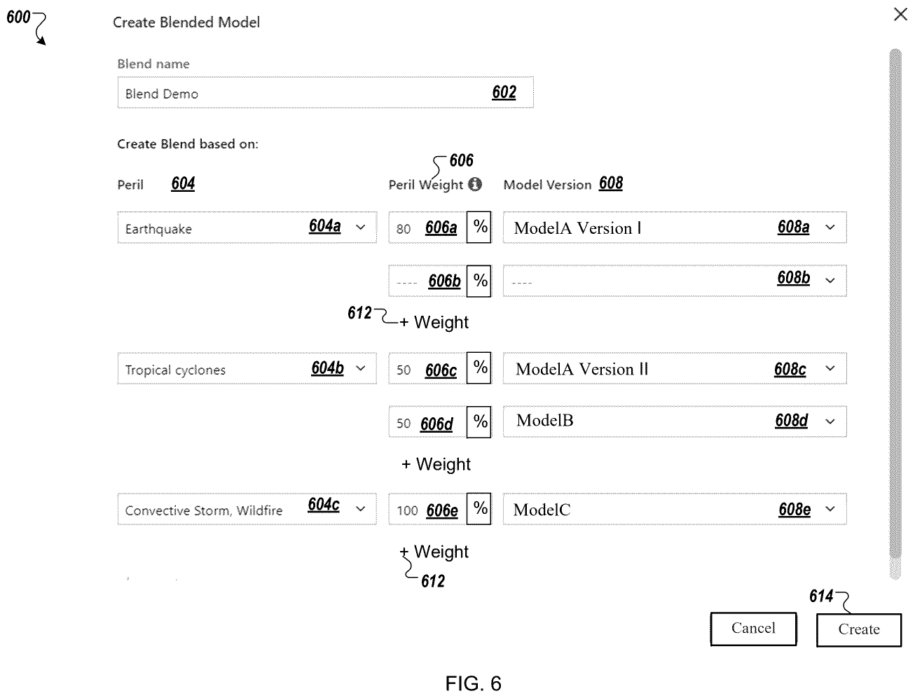

In some embodiments, a user creates a blend definition via a user interface. Turning to FIG. 6, for example, an example user interface 600 illustrates a blended model definition entry screen for creating a blend definition having a name 602 entered as “Blend Demo,” as illustrated. The user interface, for example, may be presented by the platform 102 of FIG. 1 (e.g., as a data entry user interface for the model blend defining engine 142).

As illustrated, a user may select a peril 604, illustrated having a first peril 604a of “Earthquake,” a second peril 604b of “Tropical cyclones,” and a third peril 604c of “Convective Storm, Wildfire” selected. The perils 604 may be presented in part based on the model types. For example, different model vendors may use different peril labels for selecting perils to model. In another example, different perils may be available based on the vendor (e.g., due to limited models developed by certain vendors, due to limited perils having been licensed from one or more vendors, etc.). The perils associated with vendor AIR, for example, may include earthquake, fire, inland flood, severe thunderstorm with hail, liquefaction, landslide, precipitation flood, hurricane, severe thunderstorm with straight-line winds, severe thunderstorm with tornado, terrorism, tsunami, wildfire, tropical cyclone, and/or winter storm. For each peril 604, a weight 606 of model data may be split between multiple model versions 608. For example, corresponding to the Earthquake peril 604a, a first model version 608a has a first corresponding peril weight 606a of 80% and a second corresponding peril weight 606b not yet selected. The user, in one option, may enter the second peril weight 606b as 20%, thus defining the entire peril weight for the model blend related to the earthquake peril 604. Conversely, the user, in a second option, may enter the second peril weight 606b as less than 20% (e.g., 5%, 8%, up to 19%) and select an add weight control 612 to add a third peril weight 606c (not illustrated).

Further, the user may select an add peril control (not illustrated) to add another peril 604 (e.g., other than Earthquake, Tropical cyclones, or Convective Storm-Wildfire) to the blend definition. The user may designate the same and/or different model versions 608 related to the added peril. The peril weights 606 for the designated model versions 608 designated for the added peril may differ than the peril weights 606 applied to the model versions 608a and 608b related to the earthquake peril 604a.

Once the user has completed the blend definition, the user may select a create control 614 to save the new blend definition “Blend Demo” 602. The blend definition, for example, may be saved to the blended model definitions 158 of FIG. 1. Upon saving, in some embodiments, data is generated to create the model. In some embodiments, prior to creating a blend model, the blend definition is automatically reviewed to confirm that the peril weights 606 associated with each peril 604 sum to 100%. For example, the create control 614 may not be selectable until the peril weights 606 for each peril 604 are completed (e.g., 100%). In other embodiments, upon selecting the create control 614, an error message may be presented regarding the incomplete weight 606 associated with one or more perils 604. For example, returning to FIG. 5A, in some implementations, when the combined weights fail to add to 100% for each peril of the blend definition (504), user feedback is provided regarding an error in the blend definition (506).

When the blend definition is completed with weights equaling 100% (504), in some implementations, a trial count is calculated for a blended simulation based on available trials for each model in the blend definition (508) and the model's blend weights. The trial count, for example, may be calculated by the trial count calculation engine 118 of FIG. 1. In some embodiments, the trial count is based at least in part on a number of pre-simulated trials stored in relation to each model of the blend definition. The number of pre-simulated trials, further, may be based in part on the size (e.g., number of trials) or richness of data corresponding to each model. For example, certain ETFs may be pre-simulated to 500,000 trials, while other ETFs may be pre-simulated to just 10,000 trials. Calculating the trial count may begin with analyzing available pre-simulated data sets to determine a best approach to blending the pre-simulated trials.

In some embodiments, the trial count is set to match the smallest number of pre-simulated trials across the models of the blended definition. In illustration, where model A has been pre-simulated to 500,000 trials and model B has been pre-simulated to 10,000 trials, the trial count may be set to 10,000 trials, and 5,000 trials may be sampled from model A's 500,000 trial set. However, this option could lead to wildly varying results depending upon the difference in available pre-simulated data between the models. Further to the illustration, if sampling only 1% (5,000) of the 500,000 trials of model A, the particular set of trials of the 500,000 that have been sampled can create a marked difference in results (e.g., random sampling would lead to inconsistent results). Thus, this option may be best applied where the models are within a threshold distance (e.g., percentage) in quantity of available pre-simulated trials.

In some embodiments, the trial count is set to match the largest number of pre-simulated trials across the models of the blend definition. Returning to the illustrative example posed above, the blended simulation trial count may be set to match the 500,000 trial data set of model A, and 250,000 trials may be sampled from model B's set of 10,000 trials. To conduct the sampling, for example, the 10,000 trials may be repeatedly cloned to produce the desired data set (e.g., 250,000 trials). Using the example simple blend definition presented in Table 1, above, assuming the ModelVersion A model has 500,000 pre-simulated trials available and the ModelVersion B model has 10,000 pre-simulated trials available, the 10,000 pre-simulated trials of source data of the ModelVersion B model may be used 50 times for the EQ, OW, WT and WF perils, and 25 times for the WS peril. In theory, the simulation performance should be comparable to the standard ModelVersion A model, but its results may still exhibit an undesirable amount of variance, in the illustrated example, due to failing to apply a significant proportion (e.g., half) of the pre-simulated trials of the ModelVersion A model.

In a third option, in some embodiments, the trial count is set such that all available source data is used at least once for each model identified in the blend definition. For example, a count of pre-simulated trials of the model having the largest number of pre-simulated trials of any of the models of the blend definition may be divided by the weight of the model within the blend definition to obtain an overall trial count for the blend definition. In illustration, returning to the example simple blend definition of Table 1 and applying the example 500,000 trial count to ModelVersion A and the 10,000 trial count to ModelVersion B, the 500,000 trial count, having a 50% weight for the WS peril, may be divided by 50% to obtain a 1,000,000 (one million) trial count for the blend definition. This will apply all pre-simulated trial data for each model and, thus, may be anticipated to produce superior results to the other options described above. However, in performing simulations across such a large quantity of pre-simulated trials, the processing time and/or resources required to perform the simulation of the blend definition may be unreasonable (e.g., fail to produce results in near real-time). In example, considering blend definitions with a low weighting applied to the model having the largest data set of pre-simulated trials, the resulting calculation may be unreasonably large. Thus, it may be preferable to use the third option in circumstances where the models of the blend definition each include lower numbers of trials such that a total trial count is bounded by an upper limit.

Once the trial count has been determined, in some implementations, the pre-aggregated source data corresponding to each respective model of the blend definition is filtered according to each catastrophe corresponding to the respective model and the chosen peril(s) (510). The source data, for example, may include a blend of perils including perils not designated for the respective blend definition. In this circumstance, the perils not included as one of the catastrophes corresponding to the blend definition are filtered out. Further, if a certain model includes a catastrophic event that the blend definition identifies as being represented by one or more different models, but not by the current model, even though the catastrophic event is part of the blend definition, those records may be filtered from the pre-aggregated source data of the current model.

In some implementations, the filtered, pre-aggregated source data is sampled to obtain a number of trials according to the trial count (512). The sampling, in some examples, may be performed in memory using a quantile for the independent uncertainty component of the loss, where the quantiles are obtained in a strict order. The on-the-fly loss sampling calculations may be performed using unique, fixed starting seeds for each loss segment such that the same sampling results may be obtained between different executions.

In some implementations, if a total record count of a given model is smaller than its required trial count (514), the source data for the given model is cloned to obtain the trial count of pre-aggregated source data (516). The source data may be cloned, for example, by the source data cloning engine 130 of FIG. 1. Cloning, for example, may involve cloning the source data multiple times. If, for example, the record count for a given model is 10,000, and the record count required for its contribution to the blend is 250,000, then the data may be used once and cloned twenty-four times. If the record count of the given model is larger than the remaining required records needed, in some embodiments, the first block of trials of the model (e.g., the first 50,000 records out of 200,000 records) may be cloned.

In some implementations, the simulation of the sampled trial data is executed (518). For example, the sampled trial data may be executed by the trial simulation engine 126 of FIG. 1.

Although described as a particular series of operations, in other embodiments, the method 500 may include more or fewer operations. In further embodiments, certain operations of the method 500 may be performed in a different order and/or at least partly in concurrence with other operations. Other modifications of the method 500 are possible.

FIG. 5B illustrates an example method 520 for preparing and executing a blended data trial. The method 520, for example, may be executed by the trial simulation engine 126 of FIG. 1. The method 520, for example, may use the blended data generated by the method 500 of FIG. 5A.

In some implementations, the method 520 begins with identifying, for each model in a blended model definition and for each peril or peril combination, a trial count of required trials (522). The trial count, for example, may be obtained as described in relation to the method 500 of FIG. 1. The trial count, for example, may be obtained from the trial count calculation engine 118 of FIG. 1.

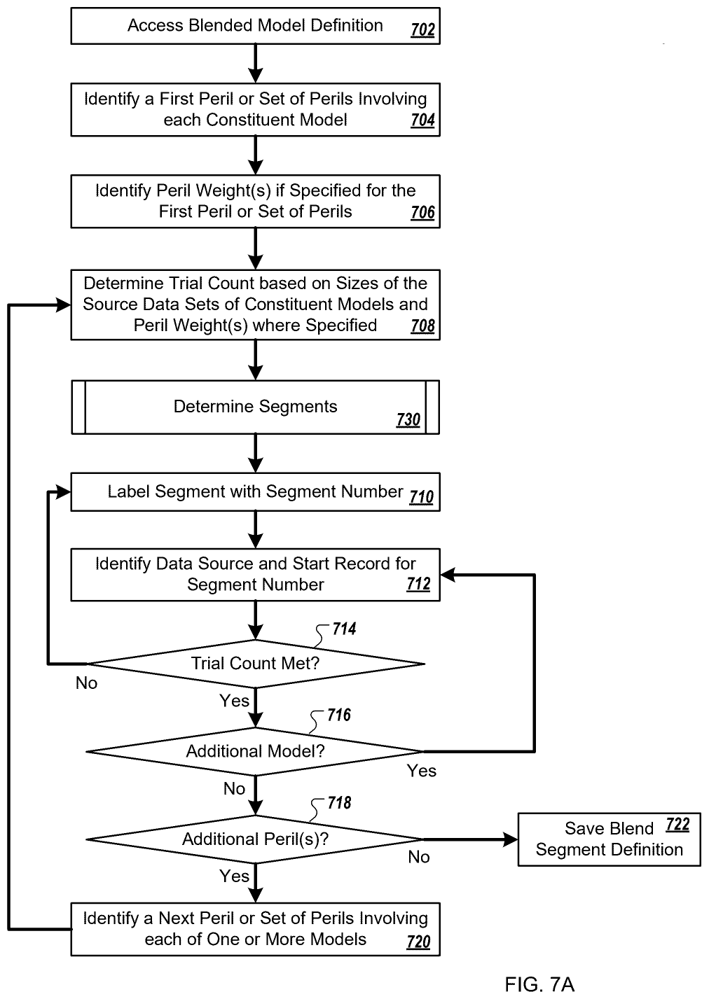

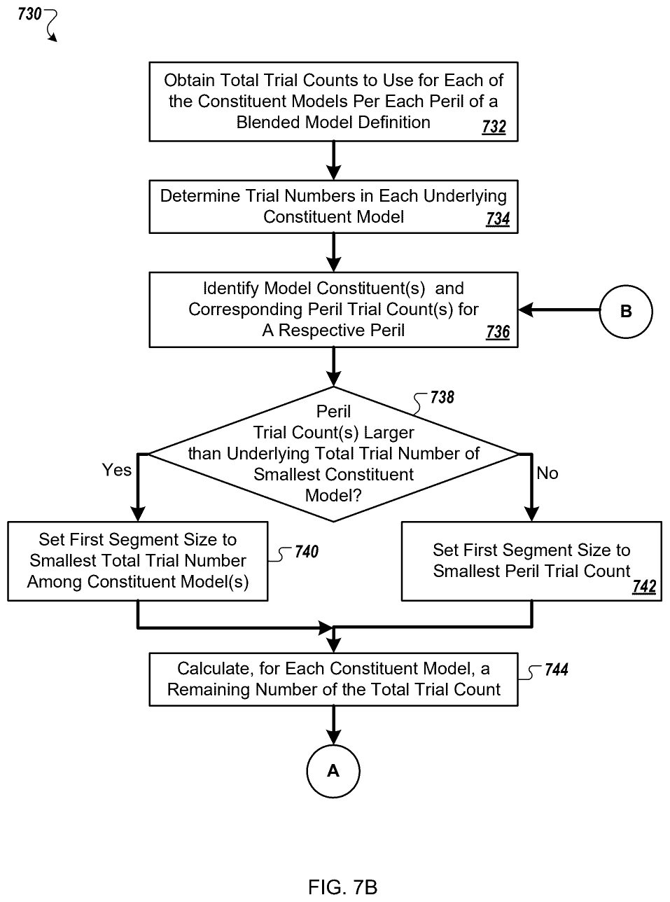

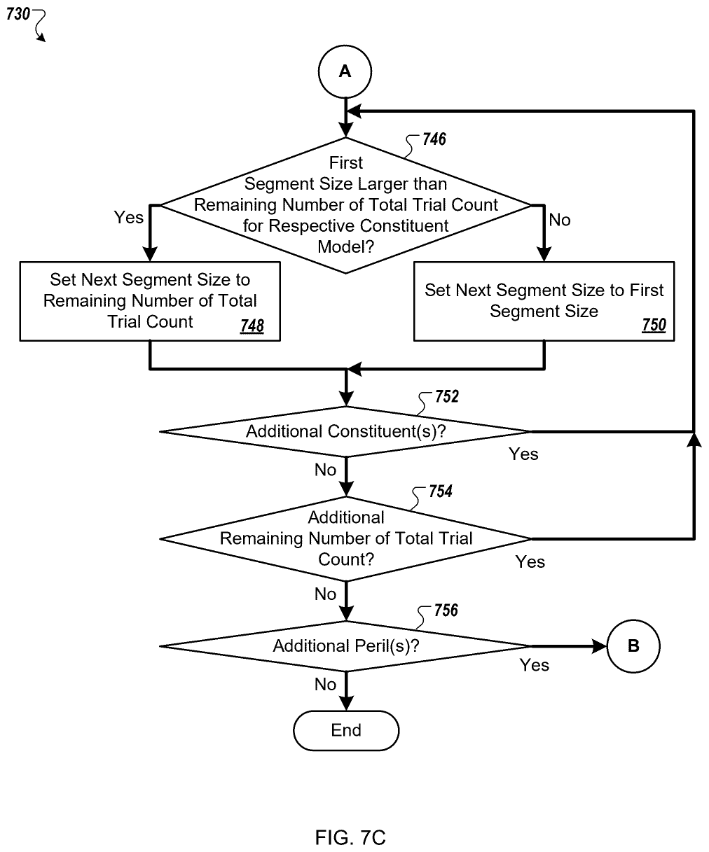

In some implementations, a set of segment definitions for separating pre-aggregated trial data into contiguous trial records is created (700). Turning to FIG. 7A, a flow chart illustrates an example method 700 for segmenting model data for performing simulations based on a blended model definition. The method 700, for example, may be performed by aspects of the impact forecasting platform 102 of FIG. 1, such as the blend segment definition engine 132.

In some implementations, the method 700 begins with accessing a blended model definition (702). The blended model definition, for example, may be provided by the method 520 of FIG. 5B. The blended model definition may be one of the blended model definitions 158 of FIG. 1. The blended model definition, in a particular example, may be defined similarly to the example simple blend model definition of Table 1, above. Another particular example is provided in the example complex blend definition of Table 2, below.

TABLE 2
Example complex blend definition

| Model Version | Peril | Weight |
|---|---|---|
| ModelVersion A | EQ | 85% |
| ModelVersion B | EQ | 15% |
| ModelVersion A | WS | 65% |
| ModelVersion B | WS | 35% |

In some implementations, a first peril or set of perils involving each constituent model of the blended model definition is identified (704). In the example of Table 2, above, the first peril or set of perils is peril EQ involving ModelVersion A (85%) and ModelVersion B (15%).

In some implementations, one or more peril weights are identified for the first peril or set of perils (706). For example, as illustrated in FIG. 6, both the first peril 604a and the second peril 604b are split between two different models, with an 80/(unfinished) split of weights 606a, 606b between the two models 608a, 608b for the first peril 604a, and a 50/50 split between the weights 606c, 606d allocated to the two models 608c, 608d designated for the second peril 604b. For the third peril 604c, a 100% weight 606e is assigned for a selected model 608e.

In some implementations, a trial count is determined based on sizes of the source data sets of the constituent models and peril weight(s) (708). The source data set size, for example, may be the size associated with the particular peril or set of perils. The weight, in the circumstance of a single constituent model being applied for a given peril, may be considered to be 100%. In some embodiments, the trial count is set to the largest of the constituent models. For example, if ModelVersion A included 500,000 trials for peril EQ and ModelVersion B included 10,000 trials for peril EQ, a trial count of 500,000 would be set. The trial count per constituent model, further, would be calculated as a percentage of the total trial count, for each peril. For example, in accordance with Table 1, 50% or 250,000 trials would be allocated to the ModelVersion A data and the other 250,000 trials would be allocated to the ModelVersion B data. In some embodiments, all trial data is used. For example, the trial count may be defined as a maximum of [constituent model trial count]/[constituent model weighting] across the different models and perils. In a particular illustration using the complex blend definition of Table 2 as an example, if ModelVersion A has native trial count 500,000 and ModelVersion B has native trial count 10,000, the trial counts for the earthquake (EQ) peril may be calculated as 500,000/0.85+10,000/0.15=654,902 trials.

As can be imagined, depending upon the number of vendors, the total number of trials per constituent data set, and the percentages selected by the user, the trial count may become very large. Thus, in some embodiments, rather than aggregating the trial counts, the largest trial count number is identified through calculating the trial count across all model constituents for all perils using the formula above (e.g., trial count divided by percentage allocated by the blended model definition). Thus, the windstorm allocation for ModelVersion A (500,000 trials/0.65 weight) would be used as the trial count (e.g., 500,000/0.65 or 769,230.7). The number may be rounded up, rounded if at or above 0.5, or rounded down as desired.

The trial count per constituent model per peril, further, can be calculated as a percentage of the total trial count. For example, for ModelVersion A and EQ peril, the trial count can be calculated as 85% of 769,231 or 653,846.1; for ModelVersion B and the EQ peril, the trial count can be calculated as 15% of 769,231 or 115,384.6; for ModelVersion A and the WS peril, the trial count can be calculated as 65% of 769,231 or 500,000; and for ModelVersion B and the WS peril, the trial count can be calculated as 35% of 769,231 or 269,230.7. The number may be rounded up, rounded if at or above 0.5, or rounded down as desired.

In some implementations, the segments of the trial data are determined (730). For example, the total simulation trial count may be divided into segments, with each segment using a pre-defined, contiguous range of loss data from a single constituent model for each peril. The number of segments and the size of each may then be determined. An example method 730 for determining the segments is provided in FIG. 7B.

Turning to FIG. 7B, in some implementations, total trial counts to use for each of the constituent models per each peril of a blended model definition are obtained (732). The total trial counts, for example, may be obtained from the method 700 of FIG. 7A.

In some implementations, the trial numbers (i.e., available trial counts) in each underlying constituent model are determined (734). The trial numbers, referencing the illustrative example used throughout, ModelVersion A may include 500,000 trials while ModelVersion B may include 10,000 trials.

In some implementations, for each respective peril, the model constituent(s) and corresponding peril trial count(s) are identified (736). The trial counts, for example, may be obtained from the method 700 of FIG. 7A (e.g., as determined by operation 708).

In some implementations, if the peril trial count(s) for at least one of the constituent models is larger than the underlying total trial number of the smallest constituent model (738), the first segment size is set to the smallest total trial number among the constituent models (740). In the illustrative example from above involving the EQ peril where the required trial count for ModelVersion A is 653,846 (with a 500,000 constituent trial number) and the required trial count for ModelVersion B is 115,385 (with a 10,000 constituent trial number), the first segment size may be set to 10,000.

If, instead, the peril trial count(s) are smaller or the same as the underlying total trial number of the smallest constituent model (738), in some implementations, the first segment size is set to the smallest peril trial count (742).

In some implementations, a remaining number of the total trial count is calculated for each constituent model (744). For example, for ModelVersion A, the remainder would be 643,846, while, for ModelVersion B, the remainder would be 105,385.

Turning to FIG. 7C, while the first segment size is smaller or equal to the remaining number of the total trial count for each constituent model (752), in some implementations, the next segment size is set to the first segment size (750). In the above example, the next segment size will continue to be 10,000.

Once the first segment size is larger than the remaining number of the total trial count for one of the respective constituent models (746), in some implementations, the next segment size is set to the remaining number of the total trial count (748). For example, after removing 10,000 from the total trial count of ModelVersion B (105,385) over and over, the remainder will eventually be 5,385—the last segment trial count.

In some implementations, while an additional remaining number of the total trial count exists for at least one of the constituent models (754), additional segments may be added (746-752). The segments may correspond to one or more of the constituent models, according to the blend definition. Further to the present example, once the ModelVersionB segments have been sized to completion for a particular peril, because a larger trial count is obtained from ModelVersion A, additional ModelVersion A segments may be defined.

In some implementations, the method 730 repeats for all additional perils defined via the blended model (756). In the example of the complex blend definition of Table 2, segments may be sized for both the earthquake peril and for the windstorm peril.

Returning to FIG. 7A, in some embodiments, each segment is labeled with a segment number (710), and a start record is identified for each segment number (712) until the trial count is met (714). As shown in a first segment definition table below corresponding to the first blend definition of Table 1, this would result in filling in the first column (segment number) and the third column (ModelVersion A, WS source data) of Table 3, below.

TABLE 3
Segment Definition Table part I for
simple blend definition of Table 1

| | Segment | ModelVersion A | ModelVersion B |
|---|---|---|---|
| Segment | Size | first source trial (WS) | first source trial (ex-WS) |
| 1 | 10,000 | 1 | 1 |
| 2 | 10,000 | 10,001 | 1 |
| 3 | 10,000 | 20,001 | 1 |
| . . . | | | |
| 25 | 10,000 | 240,001 | 1 |

In some implementations, if another model is involved in the blend definition for the peril or set of perils (716), the start record is identified for each record (712) until the trial count is met (714). This would result, for example, in filling in the fourth column of Table 3. Since ModelVersion B has only 10,000 trials, the entire set is repeated for each segment of data used from the ModelVersion A data set. Despite reusing the same data for ModelVersion B, since it will be blended in simulation with the different data sets of the ModelVersion A data, the simulations of each segment will typically obtain different results.

In some implementations, if additional perils are included (718), the next peril or set of perils involving at least one of the constituent models is identified (720). In the example of the first blend definition of Table 1, for example, the following additional segments may be defined:

TABLE 4
Segment Definition Table part II for
simple blend definition of Table 1

| | | ModelVersion B |
|---|---|---|
| Segment | Segment Size | (all perils) |
| 26 | 10,000 | 1 |
| 27 | 10,000 | 1 |
| 28 | 10,000 | 1 |
| . . . | | |
| 50 | 10,000 | 1 |

In a more complex example, Table 5, below, demonstrates segmentation of trials based on percentages of trial counts allocated as per the example complex blend definition of Table 2, using a trial count of 769,231 (e.g., 500,000 divided by 0.65, the largest number of any representative calculation based on the complex blend definition of Table 2).

TABLE 5
Segment Definition Table for complex blend definition of Table 2

| | 1st Simulated | Segment | EQ | EQ First | WS | WS First |
|---|---|---|---|---|---|---|
| Segment | Trial Number | Size | Model | Source Trial | Model | Source Trial |
| 1 | 1 | 500,000 | Version A | 1 | Version A | 1 |
| 2 | 500,001 | 10,000 | Version A | 1 | Version B | 1 |
| 3 | 510,001 | 10,000 | Version A | 10,001 | Version B | 1 |
| 4 | 520,001 | 10,000 | Version A | 20,001 | Version B | 1 |
| 5 | 530,001 | 10,000 | Version A | 30,001 | Version B | 1 |
| 6 | 540,001 | 10,000 | Version A | 40,001 | Version B | 1 |
| 7 | 550,001 | 10,000 | Version A | 50,001 | Version B | 1 |
| 8 | 560,001 | 10,000 | Version A | 60,001 | Version B | 1 |
| 9 | 570,001 | 10,000 | Version A | 70,001 | Version B | 1 |
| 10 | 580,001 | 10,000 | Version A | 80,001 | Version B | 1 |
| 11 | 590,001 | 10,000 | Version A | 90,001 | Version B | 1 |
| 12 | 600,001 | 10,000 | Version A | 100,001 | Version B | 1 |
| 13 | 610,001 | 10,000 | Version A | 110,001 | Version B | 1 |
| 14 | 620,001 | 10,000 | Version A | 120,001 | Version B | 1 |
| 15 | 630,001 | 10,000 | Version A | 130,001 | Version B | 1 |
| 16 | 640,001 | 10,000 | Version A | 140,001 | Version B | 1 |
| 17 | 650,001 | 3,846 | Version A | 150,001 | Version B | 1 |
| 18 | 653,847 | 6,154 | Version B | 1 | Version B | 3,847 |
| 19 | 660,001 | 3,846 | Version B | 6,155 | Version B | 1 |
| 20 | 663,847 | 6,154 | Version B | 1 | Version B | 3,847 |
| 21 | 670,001 | 3,846 | Version B | 6,155 | Version B | 1 |
| 22 | 673,847 | 6,154 | Version B | 1 | Version B | 3,847 |
| 23 | 680,001 | 3,846 | Version B | 6,155 | Version B | 1 |
| 24 | 683,847 | 6,154 | Version B | 1 | Version B | 3,847 |
| 25 | 690,001 | 3,846 | Version B | 6,155 | Version B | 1 |
| 26 | 693,847 | 6,154 | Version B | 1 | Version B | 3,847 |
| 27 | 700,001 | 3,846 | Version B | 6,155 | Version B | 1 |
| 28 | 703,847 | 6,154 | Version B | 1 | Version B | 3,847 |
| 29 | 710,001 | 3,846 | Version B | 6,155 | Version B | 1 |
| 30 | 713,847 | 6,154 | Version B | 1 | Version B | 3,847 |
| 31 | 720,001 | 3,846 | Version B | 6,155 | Version B | 1 |
| 32 | 723,847 | 6,154 | Version B | 1 | Version B | 3,847 |
| 33 | 730,001 | 3,846 | Version B | 6,155 | Version B | 1 |
| 34 | 733,847 | 6,154 | Version B | 1 | Version B | 3,847 |
| 35 | 740,001 | 3,846 | Version B | 6,155 | Version B | 1 |
| 36 | 743,847 | 6,154 | Version B | 1 | Version B | 3,847 |
| 37 | 750,001 | 3,846 | Version B | 6,155 | Version B | 1 |
| 38 | 753,847 | 6,154 | Version B | 1 | Version B | 3,847 |
| 39 | 760,001 | 3,846 | Version B | 6,155 | Version B | 1 |
| 40 | 763,847 | 5,385 | Version B | 1 | Version B | 3,847 |

In the above example, rather than determining a trial count on a per peril/set of perils basis (704, 706), the trial count may be based on the source data set counts and peril weights applied within the entire blend definition. Other modifications of the method 700 are possible.

In some implementations, the blend segment definition is saved (722). The definition may be saved to the blend segment definitions 162 of the data repository 110 of FIG. 1.

Returning to FIG. 5B, in some implementations, if the segment definition includes any duplicate segments (524), the duplicate segments are removed (526). A duplicate segment includes any segment including a same set of records from each model constituent contributing to that segment, and whose simulation results would therefore be expected to be identical. The duplicate may be eliminated with the retained segment's results given greater weight in the statistic calculation process, to ensure that the results are unaffected by this optimization. For example, as illustrated in Table 4, segment 18 and segment 20 include the same starting trial and the same range of records for both ModelVersion A and ModelVersion B, making segment 20 a duplicate of segment 18. Thus, segment 20 may be removed. Similarly, segments 19 and 21 are duplicates, segments 22 and 24 are duplicates, and so on. The pattern repeats through segment 39, with segment 40 being a unique segment. In some embodiments, the duplicate segment removal engine 120 of FIG. 1 removes duplicate segments from the blend segment definitions 162.

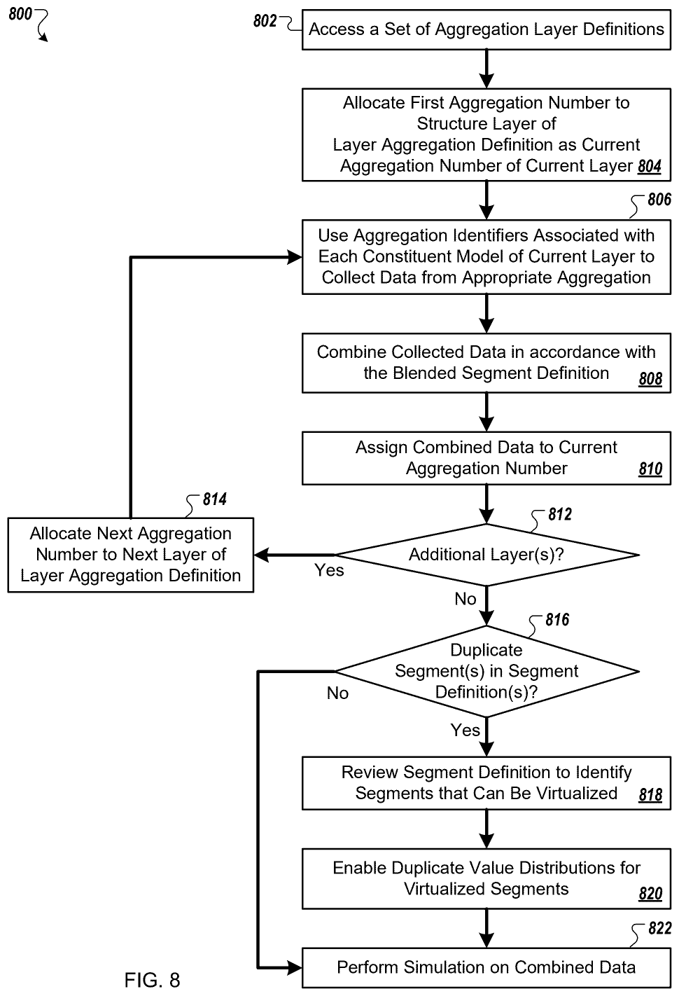

In some implementations, a simulation is executed on the segmented trial data (800). The simulation, for example, may be performed in the manner described in relation to a method 800 of FIG. 8. The trial simulation engine 126 of FIG. 1 may perform the simulation.

Turning to FIG. 8, in some implementations, the method 800 begins with accessing a set of layer aggregation definitions corresponding to the source model versions used in the blended model definition (802). The layer aggregation definitions provide information regarding the loss data for each relevant peril to the model. If a certain peril is not included in a given model, in some embodiments, a “no data” indication is included in the layer aggregation definition. The set of layer aggregation definitions, for example, may be obtained from the layer aggregation definitions 154 of the data repository 110 of FIG. 1. The layer aggregation definitions 154 can be created for each source model version to reflect the subset of loss segments applicable to each layer, together with any scaling factors. The scaling factors, in some embodiments, default to 1 unless the catastrophic model output is to be scaled. Scaling, in an illustrative example, may be used in creation of an adjusted model version (e.g., as shown by the scaling factor 410b in the user interface 400 of FIG. 4) to adjust results based on underlying business changes (e.g., a line of business grew by 10%, so its results are set to be scaled to 1.1). The set of layer aggregation definitions, for example, may be generated based on layers of a reinsurance structure, such as the reinsurance structures 156 of the data repository 110. An example layer aggregation definition for a blended simulation is provided below.

TABLE 6
Example layer aggregation definitions for a blended simulation

| Purpose | ModelVersion A | ModelVersion B |
|---|---|---|
| Structure | 1005 | 2080 |
| Layer #1 Primary Aggregation | 1005 | 2083 |
| Layer #2 Primary Aggregation | 1006 | 2084 |

Other aggregation layer definitions may include more or fewer layers, but each aggregation definition begins with the structure aggregation (overall totals). Further, in some embodiments, layer(s) may be inured by other layer(s) (e.g., layer 2 may be inured to layer 1), creating the requirement for intersection aggregation definitions.

In some implementations, a first aggregation number is allocated to the “overall totals” aggregation definition as the current aggregation number of the current layer (802). In a standard, non-blended simulation, the layer identifiers for each layer can be used to index data. However, because the blended aggregation layer definition involves multiple constituent models, another indexing scheme can be used to provide unique identifiers to the aggregations of each layer. The aggregation numbers, for example, may range from 0 to N or 1 to X. The first aggregation number may be allocated by the blended data aggregation engine 136 of FIG. 1.

In some implementations, the aggregation identifiers associated with each constituent model of the current layer are used to collect data from the appropriate aggregation (806). In the example of the Segment Definition Table of Table 5, for the first segment, all data is obtained from aggregation identifier 1005 (ModelVersion A data), in accordance with the aggregation definitions of Table 6. Further to the example, for the second segment, the EQ data can also be collected from aggregation identifier 1005, while the WS data can be collected from aggregation identifier 2080 (ModelVersion B data). The data may be collected, for example, by the blended data aggregation engine 136 of FIG. 1. Although illustrated as being associated with particular model versions, the aggregation identifiers, in some implementations, are globally unique, such that the aggregation identifiers will be unique across all event loss files. Thus, the aggregation indexes, rather than being allocated per model, may be allocated without considering its source. Further, where scaling factors are applied (e.g., for adjusted model versions), additional aggregations may be created with new aggregation identifiers.

In some implementations, the collected data is combined in accordance with the blended segment definition (808). For example, for segment 2, the collected trials from aggregation identifier 1005 (ModelVersion A data) and aggregation identifier 2080 (ModelVersion B data) may be filtered for EQ and WS, respectively, and combined. The data may be combined, for example, by the blended data aggregation engine 136 of FIG. 1.

In some implementations, the combined data is assigned to the current aggregation number (810). All of the combined data for each data of the blended segment definition, gathered in accordance to the current (e.g., primary) layer of the blended aggregation layer definition, is assigned the same aggregation number. The aggregation number may be assigned to the combined data sets, for example, by the blended data aggregation engine 136 of FIG. 1.

In some implementations, for each additional layer (812) of the blended aggregation layer definition, the next aggregation number is allocated to the additional layer (814), the aggregation identifiers associated with each constituent model of the next layer are used to collect data from the appropriate aggregation (806), the collected data is combined in accordance with the blended segment definition (808), and the combined data is assigned to the next aggregation number (810).

In some implementations, if the segment definition table includes one or more duplicate segments (816), the segment definition is reviewed to identify segments that can be virtualized (818). Rather than recalculating a set of results based on the same information, trial simulation processing may be accelerated and processing resources reserved through virtually cloning identical results. In the segment definition table, for example, each pair or set of entries having the same range of trials for each and every constituent may be flagged as duplicate segments. The blended data cloning engine 144 of FIG. 1, for example, may flag duplicate segments for virtualization purposes. Duplicate segments, for example, as discussed in relation to duplicate segment removal at operation 526 of FIG. 5B.

In some implementations, duplicate value distributions are enabled for virtualized segments (820). For example, a number of duplicate entries, or a total number of matching entries (e.g., one that is calculated and the remainder to be “cloned”) may be flagged in relation to each calculation corresponding to duplicate segments such that, upon calculating statistical values for trial simulation results such as, in some examples, mean, standard deviation, etc., the number of duplicates is taken into account in the calculation.

In some implementations, a simulation is performed on the combined data (822). For example, the trial simulation engine 126 of FIG. 1 may perform the trial calculations.

Although described as a particular series of operations, in other embodiments, the method 800 may include more or fewer operations. In further embodiments, certain operations of the method 800 may be performed in a different order and/or at least partly in concurrence with other operations. Other modifications of the method 800 are possible.

Reference has been made to illustrations representing methods and systems according to implementations of this disclosure. Aspects thereof may be implemented by computer program instructions. These computer program instructions may be provided to a processor of a general purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the method 200 of FIG. 2, the method 300 of FIG. 3, the method 500 of FIG. 5A, the method 520 of FIG. 5B, the method 700 of FIG. 7A, the method 730 of FIG. 7B and FIG. 7C, and/or the method 800 of FIG. 8.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the impact forecasting of catastrophic perils platform 102 and the clients 104 and/or the catastrophic model data source(s) 106.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in the user interface 400 of FIG. 4 and/or the user interface 600 of FIG. 6.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. For example, the contents of the data repository 110 of FIG. 1 may be maintained in a database structure.

The systems described herein may communicate with the cloud computing environment through a secure gateway. In some implementations, the secure gateway includes a database querying interface, such as the Google BigQuery™ platform or Amazon RDS™. The data querying interface, for example, may support access by the impact forecasting of catastrophic perils platform 102 to the catastrophic model data source(s) 106 of FIG. 1.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system for performing simulations using a customized catastrophic risk model generated from one or more constituent catastrophic risk models, the system comprising:
a non-transitory data storage region configured to store a plurality of catastrophic risk models, each risk model of the plurality of catastrophic risk models comprising a plurality of loss records; and
processing circuitry configured as hardware logic and/or configured to execute software logic stored to a non-transitory computer-readable medium as executable instructions, the processing circuitry being configured to perform operations comprising
receiving a blend definition identifying
two or more models of the plurality of catastrophic risk models, and
at least one peril for each model of the two or more models,
calculating one or more trial counts based at least in part on available trials for each model in the blend definition,
collecting sets of sampled trial data by sampling, for each respective model of the two or more models, the plurality of loss records for the respective model according to a respective trial count of the one or more trial counts corresponding to the respective model to obtain a set of sampled trial data of the sets of sampled trial data for the respective model, and
executing a simulation using the sets of sampled trial data.

2. The system of claim 1, wherein:
the blend definition comprises, for each combination of a respective model of the two or more models and a respective peril identified in relation to the respective model, a respective peril-model weight; and
the one or more trial counts are calculated further in part on the respective peril-model weight corresponding to each model of the two or more models.

3. The system of claim 1, wherein sampling comprises, for a given model of the two or more models having a total number of the plurality of loss records of the given model smaller than the respective trial count for the given model, cloning at least a portion of the plurality of loss records for the given model to reach the respective trial count for the given model.

4. The system of claim 1, wherein the operations further comprise:
determining, based at least in part on the one or more trial counts and a total number of the plurality of loss records of each model of the two or more models, numbers and sizes of a plurality of segments of sampled trial data, wherein
executing the simulation comprises executing the simulation on the plurality of segments of sampled trial data.

5. The system of claim 4, wherein the operations further comprise:
identifying one or more duplicate segments of the plurality of segments of sampled trial data;
wherein executing the simulation comprises
removing additional segments matching each duplicate segment of the one or more duplicate segments, and
aggregating simulation results for each respective duplicate segment of the one or more duplicate segments according to a number of the additional segments matching the respective duplicate segment.

6. The system of claim 1, wherein a first model of the two or more models of the blend definition corresponds to a first model vendor, and a second model of the two or more models of the blend definition corresponds to a second model vendor.

7. The system of claim 6, wherein a first model of the two or more models of the blend definition corresponds to a first version of a catastrophic model, and the second model of the two or more models of the blend definition corresponds to a second version of the catastrophic model.

8. The system of claim 1, wherein the plurality of loss records are a plurality of pre-aggregated loss records.

9. A method for pre-aggregating loss data in preparation for performing catastrophic peril simulations, the method comprising:
obtaining, by processing circuitry, a catastrophic model comprising a set of event data records related to one or more types of catastrophic risk;
generating, by the processing circuitry, a set of year event loss data records by pre-simulating each respective constituent event loss data set of the catastrophic model into a respective year-loss data set of the set of year event loss data records;
aggregating, by the processing circuitry, the set of year loss data records to produce a set of sample year losses at one or more levels relevant to a predetermined set of risk calculations;
by the processing circuitry, calculating, using the set of sample year losses, a set of gross loss characteristics;
comparing, by the processing circuitry, the set of gross loss characteristics to a corresponding set of anticipated gross loss characteristics to confirm the set of gross loss characteristics is within a target threshold of the set of anticipated gross loss characteristics; and
responsive to confirming the set of gross loss characteristics is within the target threshold, storing, by the processing circuitry, the set of year event loss data records as a pre-simulated version of the catastrophic model.

10. The method of claim 9, wherein:
the catastrophic model is an adjusted model version defined as a base catastrophic model in addition to one or more adjustment parameters; and
generating the set of year event loss data records results in applying the one or more adjustment parameters to original loss data of the catastrophic model.

11. The method of claim 10, wherein the one or more adjustment parameters are applied to at least one event loss table of the set of event data records.

12. The method of claim 11, wherein the at least one event loss table comprises one or more year event loss tables.

13. The method of claim 11, wherein the one or more adjustment parameters comprises at least one of a percentage loss adjustment or an absolute value loss adjustment.

14. The method of claim 10, wherein obtaining the catastrophic model comprises receiving the one or more adjustment parameters and an identification of an original catastrophic model.

15. The method of claim 14, wherein the original catastrophic model is a blended model.

16. A system for simulating segmented catastrophic risk model trial data, the system comprising:
a non-transitory data storage region configured to store a plurality of catastrophic risk models, each risk model of the plurality of catastrophic risk models comprising a plurality of loss records; and
processing circuitry configured as hardware logic and/or configured to execute software logic stored to a non-transitory computer-readable medium as executable instructions, the processing circuitry being configured to perform operations comprising
obtaining a blended model definition identifying each catastrophic risk model of a subset of the plurality of catastrophic risk models and, for each respective catastrophic risk model of the subset, at least one peril of a plurality of catastrophic risk perils,
accessing a set of aggregation layer definitions identifying each catastrophic risk model of the subset of the plurality of catastrophic risk models, wherein
each aggregation layer definition of the set of aggregation layer definitions corresponds to a respective layer of a reinsurance structure, and
each aggregation layer definition of the set of aggregation layer definitions identifies, for each respective risk model of the subset of catastrophic risk models, a respective segment of the plurality of loss records of the respective risk model relevant to the respective layer of the reinsurance structure,
for each respective aggregation layer definition of the set of aggregation layer definitions,
for each respective risk model of the respective aggregation layer definition, collecting the respective segment of the plurality of loss records from the respective risk model in accordance with the respective aggregation layer definition as respective trial data of the respective risk model, and
combining the respective trial data collected from each respective risk model in accordance with respective perils identified in the blended model definition to produce a respective combined trial data set, and
executing a simulation using the respective combined trial data set for each respective aggregation layer definition.

17. The system of claim 16, wherein the processing circuitry is configured to perform further operations comprising, prior to executing the simulation:
identifying one or more sets of duplicated trial data, each set of duplicate trial data comprising two or more respective combined trial data sets representing a same plurality of combined data records, and
flagging, for each respective set of the one or more sets of duplicated trial data, each additional combined trial data set of the two or more respective combined trial data sets as a respective virtualized trial data set for cloning, such that a respective single trial data set of the respective set remains absent flagging;
wherein executing the simulation comprises virtual cloning results from the respective single trial data set for each additional combined trial data set of the respective set.

18. The system of claim 16, wherein the processing circuitry is configured to perform further operations comprising:
prior to collecting the respective segment of the plurality of loss records from the respective risk model, allocating a first aggregation number of a plurality of aggregation numbers, wherein the respective segment of the plurality of loss records collected from a first risk model of a first aggregation layer definition is assigned the first aggregation number; and
for each subsequent aggregation layer definition of the set of aggregation layer definitions, allocating a next aggregation number of the plurality of aggregation numbers;
wherein executing the simulation comprises indexing each respective combined trial data set according to the plurality of aggregation numbers.

19. The system of claim 16, wherein:
the blended model definition identifies, for each model of at least two models of the subset of the plurality of catastrophic risk models identified in relation to a given peril of the at least one peril, a respective corresponding weight; and
producing at least one respective combined trial data set comprises combining the respective trial data collected from each respective risk model of the at least two models in accordance with the respective corresponding weight of the given peril for each model of the at least two models.

20. The system of claim 16, wherein the plurality of catastrophic risk perils comprises at least one of cyclone, hurricane, typhoon, windstorm, winter storm, flood, wildfire, infectious disease, terrorism, war, and/or cybersecurity breach.
